(19) United States
(12) Patent Application Publication
(10) Pub. No.: US 2012/0032849 A1
(43) Pub. Date: Feb. 9, 2012

(54) Multi-Orientation Phased Antenna Array and Associated Method

(75) Inventors: William P. Hull, JR., Fairview, TX (US); George F. Barson, Plano, TX (US); James S. Wilson, Hurst, TX (US); James M. Irion, II, Allen, TX (US)

(73) Assignee: Raytheon Company, Waltham, MA (US)

(21) Appl. No.: 12/851,174

(22) Filed: Aug. 5, 2010

(51) Int. Cl. H01Q 3/02; H01Q 3/24; H01Q 21/00; H01Q 1/42

(52) U.S. Cl. 342/374; 343/872; 343/879; 343/876

(57) ABSTRACT

According to one embodiment, an antenna apparatus includes first and second antenna arrays configured in a support structure. Each antenna array has multiple antenna elements that transmit and/or receive electro-magnetic radiation. The elements of the first antenna array are oriented in a boresight direction that is different from the boresight direction in which the elements of the second antenna array are oriented. A plurality of switches alternatively couples the first antenna elements or the second antenna elements to a signal distribution circuit.

### TECHNICAL FIELD OF THE DISCLOSURE

This disclosure generally relates to antenna arrays, and more particularly, to a multi-orientation phased antenna array and associated method.

### BACKGROUND OF THE DISCLOSURE

Electro-magnetic radiation at microwave frequencies has relatively more distinct propagation and/or polarization characteristics than electro-magnetic radiation at lower frequencies. Antenna arrays that transmit and receive electro-magnetic radiation at microwave frequencies, such as (AESAs), may be useful for transmission and/or reception of microwave signals at a desired polarity, scan pattern, and/or look angle. AESAs are typically driven by a signal distribution circuit that generates electrical signals for transmission by the AESA, and may also be used to condition electro-magnetic signals received by the active electronically scanned array.

### SUMMARY OF THE DISCLOSURE

According to one embodiment, an antenna apparatus includes first and second antenna arrays configured in a support structure. Each antenna array has multiple antenna elements that transmit and/or receive electro-magnetic radiation. The elements of the first antenna array are oriented in a boresight direction that is different from the boresight direction in which the elements of the second antenna array are oriented. A plurality of switches alternatively couples the first antenna elements or the second antenna elements to a signal distribution circuit.

Some embodiments of the disclosure may provide numerous technical advantages. For example, one embodiment of the multi-orientation antenna array may provide up to twice the field-of-view (FOV) relative to other antenna arrays that only generate transmit or receive beam in a single direction. This expanded FOV is provided by two antenna arrays that are mounted together in a configuration such that two independently controlled beams may be generated. This configuration of the two antenna arrays may also enable re-use of certain components for reduced weight, size, and costs relative to other antenna arrays. In certain cases, the antenna apparatus may also forego the need for gimbal and servo mechanisms that may further reduce the cost, weight, and power requirements associated with antenna arrays.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is an illustration showing one embodiment of a multi-orientation antenna array according to the teachings of the present disclosure;

FIGS. 2A and 2B are enlarged, perspective and enlarged, exploded views, respectively, showing one embodiment of a modular element assembly that forms a portion of each antenna array of FIG. 1;

FIG. 3 is a schematic diagram showing a coupling arrangement of the various components that may be implemented on one embodiment of a modular element assembly as shown with respect to FIG. 2;

FIG. 4 is a schematic diagram showing another coupling arrangement of the various components that may be implemented on another embodiment of a modular element assembly of FIG. 2;

FIG. 5 is a schematic diagram showing another coupling arrangement of the various components that may be implemented on another embodiment of a modular element assembly of FIG. 2;

FIG. 6 is an illustration showing a perspective view of another embodiment of a combined antenna array in which two multi-orientation antenna arrays of FIG. 1 are configured in a perpendicular relationship relative to one another along a common azimuthal axis;

FIG. 7 is an illustration showing a perspective view of another embodiment of the multi-orientation antenna array according to the teachings of the present disclosure; and

FIG. 8 illustrates a top view of one embodiment of a modular element assembly that forms a portion of each antenna array of FIG. 7.

### DETAILED DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

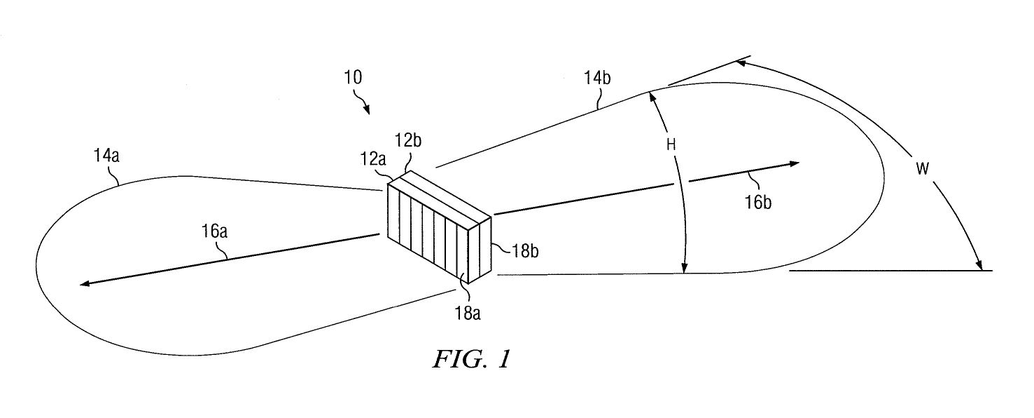

FIG. 1 is an illustration showing one embodiment of a multi-orientation antenna array 10 according to the teachings of the present disclosure. Multi-orientation antenna array 10 includes a first antenna array 12a and a second antenna array 12b arranged in a support structure that in this particular embodiment, includes an enclosure that is common to first antenna array 12a and a second antenna array 12b. Each antenna array 12a and 12b transmits or receives electro-magnetic radiation represented by scan volumes 14a and 14b having an azimuthal width W and an elevation height H. As will be described in detail below, multi-orientation antenna array 10 provides an enhanced scan volume without incurring drawbacks of conventional active electronically scanned arrays (AESAs), using switches that alternatively couple corresponding first antenna array 12a or second antenna array 12b to a signal distribution circuit.

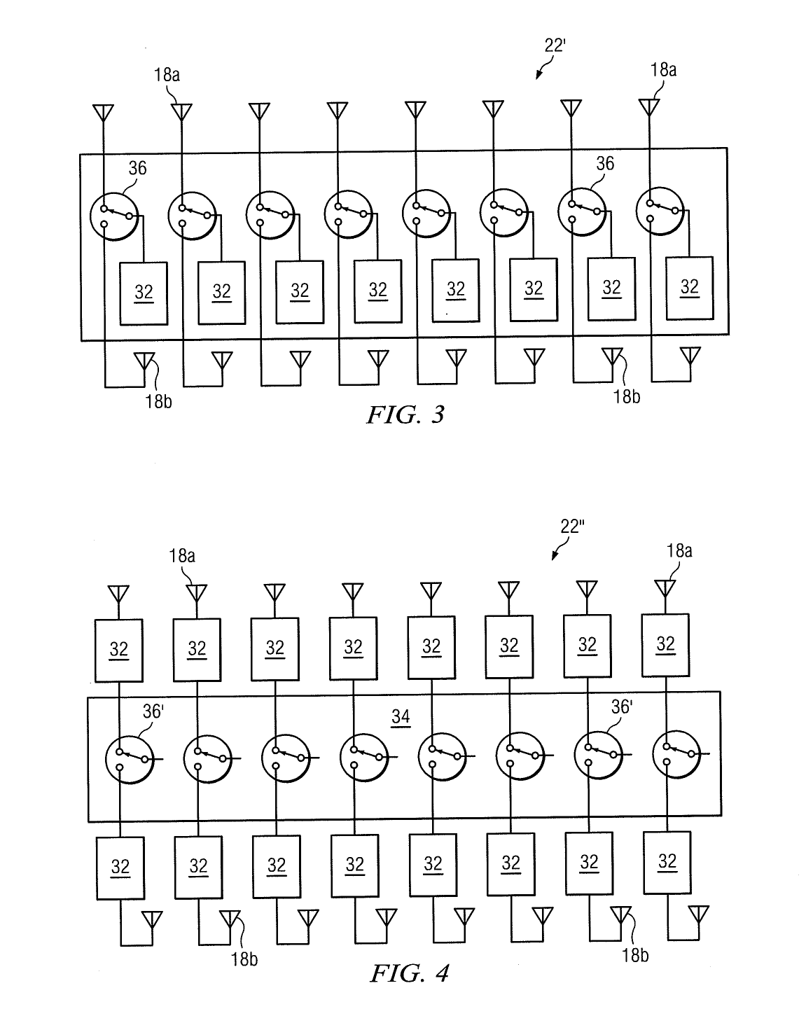

First antenna array 12a includes multiple antenna elements 18a that are oriented in a plane perpendicular to direction 16a; and second antenna array 12b includes multiple antenna elements 18b that are oriented in a plane perpendicular to direction 16b. When antenna elements 18a of first antenna array 12a are energized with signals having a similar amplitude and phase, it generates a beam within scan volume 14a. Likewise, when antenna elements 18b of second antenna array 12b are energized with signals having a similar amplitude and phase, it generates a beam within the scan volume 14b. Switches may be implemented to alternatively couple antenna elements 18a or antenna elements 18b to drive circuitry in multi-orientation antenna array 10. Additional details of certain embodiments of switch configurations that may be implemented are described in detail with respect to FIGS. 3 and 4.

In the particular embodiment shown, antenna arrays 12a and 12b operate at frequencies in the range of 8 to 10 Gigahertz (GHz), have an aperture size of approximately 4 feet², and has a peak transmitting power of approximately 5 Watts peak power per radiating element. Other embodiments may have similar or differing characteristics including lower or higher frequencies, lower or higher peak power per element, and different aperture sizes. In the particular embodiment shown, each antenna array 12a and 12b provides a scan volume 14a and 14b having an azimuthal width W of approximately 120 degrees and an elevational height H of approximately 60 degrees. Thus, the effective scan volume 14a and 14b provided by antenna array 10 may be approximately 240 degrees along the azimuthal extent around antenna array 10. In other embodiments, each antenna array 12a and 12b may have an azimuthal width W greater than 120 degrees or less than 120 degrees. Additionally, each antenna array 12a and 12b may have an elevational height H greater than 60 degrees or less than 60 degrees.

First and second antenna arrays 12a and 12b may have any suitable number and type of antenna elements 18a and 18b. In the particular embodiment shown, each antenna array 12a and 12b includes two polarized radiating elements that are orthogonal relative to one another. In other embodiments, each antenna array 12 may include only a single polarized radiating element 18, or one antenna array 12a may include only a single polarized radiating element 18 while the other antenna array 12b includes only a single polarized element 18 that is orthogonal to radiating element 18 configured on antenna array 12a.

Certain embodiments of antenna array 10 may provide an enhanced field-of-view (FOV) for scan volumes 14a and 14b that may be 180 degrees, or approximately 180 degrees, with respect to one another at a reduced weight and cost relative to known antenna arrays. Antenna array utilizes two sets of antenna elements 18a and 18b housed in a common support structure. In certain embodiments, antenna elements 18a and 18b share common radio frequency (RF), power circuitry, signal circuits, structural plates, and/or cooling structures. This commonality may provide reduced weight and/or cost relative to other antenna arrays.

AESAs may provide inertialess scanning over a FOV that is limited by the element pattern of the individual radiating elements. Antenna arrays having a relatively large FOV have typically been achieved by either mounting the AESAs on a gimbal having a servo mechanism to position the FOV at the desired angle, or by configuring multiple AESAs in a fixed installation. For the particular case in which the desired FOVs of the two scan volumes 14a and 14b are 180 degrees with respect to one another, the invention described herein may provide an antenna array 10 having reduced weight and lower cost relative to the known AESAa in certain embodiments.

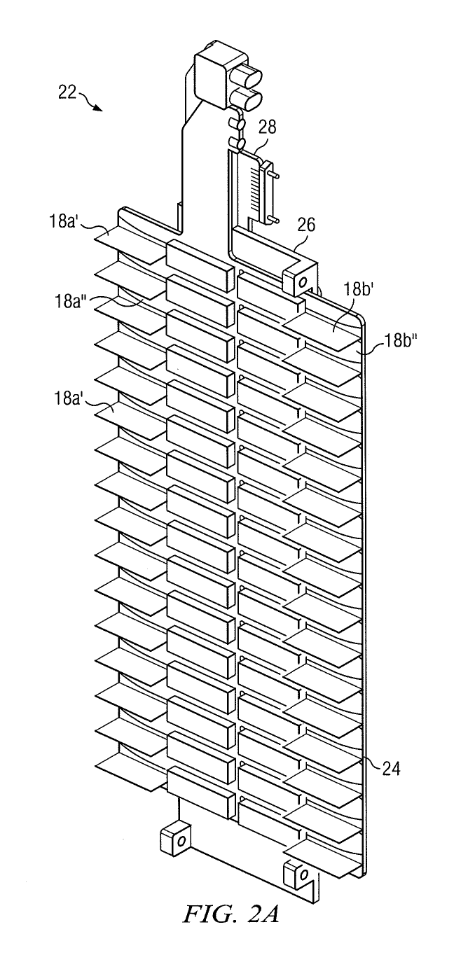

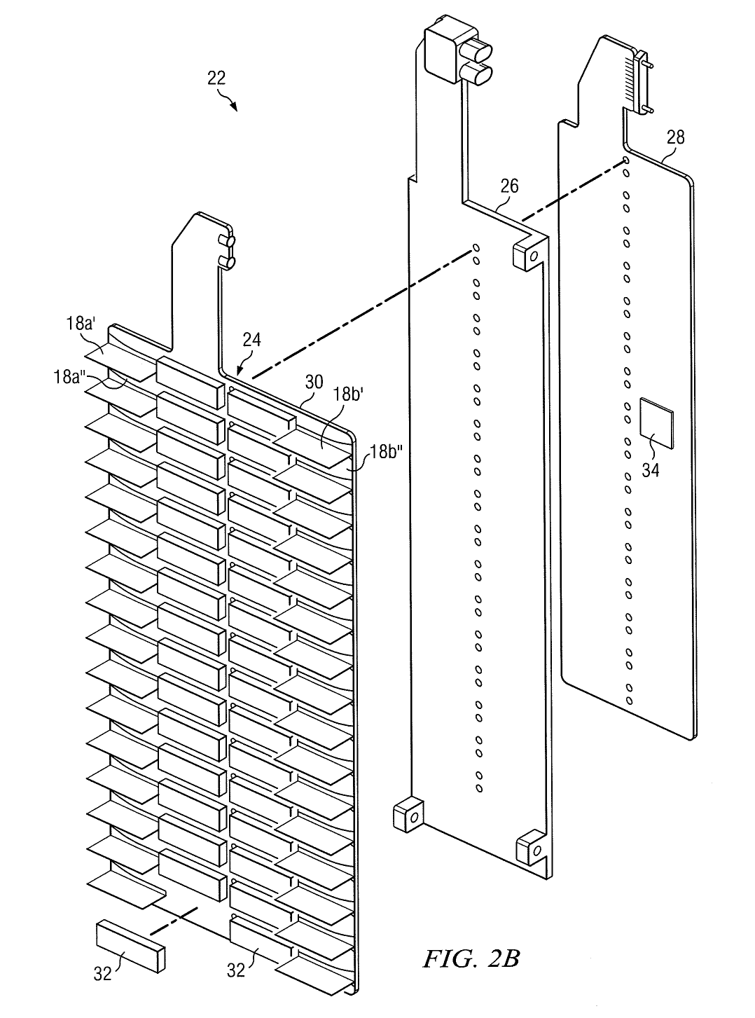

FIGS. 2A and 2B are enlarged, perspective and enlarged, exploded views, respectively, showing one embodiment of a modular element assembly 22 that forms a portion of each antenna array 12a and 12b of FIG. 1. Modular element assembly 22 includes a circuit board 24, a coldplate 26, and a power and control signal interface board 28. In certain embodiments, power and control interface 28 may be included in modular element assembly 22 or be a separate circuit board. Multiple modular element assemblies 22 may be stacked beside each other to form first antenna array 12a and second antenna array 12b.

Circuit board 24 includes a printed wiring board 30, multiple signal channels 32, and multiple antenna elements 18a″ and 18b″, and multiple switches 36 or 36′ (FIG. 3 or 4). Circuit board 24 may also include antenna elements 18a′ and 18b′ that are oriented orthogonally relative to antenna elements 18a″ and 18b″. Signal channels 32 may include active and/or passive circuitry utilized to provide the amplitude and phase for the radiated or received signals. Signal channels 32 may be packaged in hermetic modules or be packaged without hermetic modules in which protective coatings or other means are applied to provide suitable control of the environment around signal channels 32.

In the particular embodiment shown, antenna elements 18a′, 18b′, 18a″, and 18b″ comprise slotline radiators. In certain embodiments, antenna elements 18a′, 18b′, 18a″, and 18b″ may be any device that is adapted to radiate electro-magnetic radiation upon excitation at a desired frequency.

Power and control interface 28 may include various components that may include, but are not limited to one or more signal distribution circuits 34.

When arranged in multi-orientation antenna array 10, one outer edge of circuit board 24 is aligned along the aperture of first antenna array 12a and its other outer edge is aligned with the aperture of second antenna array 12b. Thus, antenna elements 18a of antenna array 12a and antenna elements 18b of antenna array 12b may be formed on a common printed wiring board. Certain embodiments of multi-orientation antenna array 10 may provide advantages over other antenna arrays in that multiple antenna arrays 12a and 12b may leverage reduced parts count of certain components for reduced weight, size, and/or cost relative to other antenna array designs.

Coldplate 26 is thermally coupled to printed wiring board 24 and functions as a cooling system to convey heat away from signal channels 32 during operation of multi-orientation antenna array 10. In the particular embodiment shown, coldplate 26 is formed of a thermally conductive material, such as aluminum. In other embodiments, coldplate may be made of any suitable material and have any shape that conveys heat away from circuit board 24 or power and control interface 28. For example, coldplate 26 may include a fluid that is configured to transfer heat away from components of circuit board 24 by undergoing a phase change in the presence of close thermal coupling with its components. As can be seen, antenna array 12a and antenna array 12b share a common cooling system that further serves to reduce weight, size, and/or costs relative to other antenna array designs.

FIG. 3 is a schematic diagram showing a coupling arrangement of the various components that may be implemented on one embodiment of a modular element assembly 22′ as shown with respect to FIG. 2. This particular coupling arrangement includes multiple radiating elements 18a that form first antenna array 12a, multiple radiating elements 18b that form second antenna array 12b, and multiple signal channels 32 that transfer electrical energy to or receive electrical energy from antenna elements 18a and 18b. The coupling arrangement of modular element assembly 22′ also includes multiple switches 36 that alternatively couple signal channels 32 to each antenna element 18a and 18b of its respective antenna array 12a and 12b.

Each signal channel 32 of modular element assembly 22′ is common to first antenna array 12a and second antenna array 12b. In operation, each signal channel 32 may be alternatively coupled to either an antenna element 18a of first antenna array 12a or an antenna element 18b of second antenna array 12b. That is, first antenna array 12a or second antenna array 12b may be used while the other remains idle. Thus, the beam generated by first antenna array 12a may be steered in one direction, while the beam generated by second antenna array 12b is steered in a another direction independently of the direction in which the beam of first antenna array 12a is steered.

Switches 36 may be actuated to select which of first antenna array 12a or second antenna array 12b is used. Modular element assembly 22′ may provide an advantage in that the quantity of signal channels 32 and/or signal distribution circuits 34 used may be reduced by a factor of 2, thus providing a reduction in the weight, size, and costs relative to other antenna arrays having twice as many signal channels 32 and/or signal distribution circuits 34.

FIG. 4 is a schematic diagram showing another coupling arrangement of the various component that may be implemented on another embodiment of a modular element assembly 22″ of FIG. 2. This particular coupling arrangement includes multiple radiating elements 18a and corresponding signal channels 32 that form first antenna array 12a, and multiple radiating elements 18b and corresponding signal channels 32 that form second antenna array 12b in a manner similar to the modular element assembly 22′ as shown and described with reference to FIG. 3. Modular element assembly 22″ of FIG. 4 differs, however, in that it includes multiple switches 36′ for switching between signal channels 32 coupled to antenna elements 18a, and signal channels 32 coupled to antenna elements 18b. Additionally, a common signal distribution circuit 34 is provided that is shared by first antenna array 12a and second antenna array 12b.

Switches 36′ alternatively couple signal distribution circuit 34 between signal channels 32 of first antenna array 12a, and signal channels 32 of second antenna array 12b. In this configuration, a beam may be generated by first antenna array 12a while the second antenna array 12b is idle. Alternatively, another beam may be generated by the second antenna array 12b while the first antenna array 12a is idle. Embodiments of modular element assembly 22″ may provide an advantage over modular element assembly 22′ of FIG. 3 in that signal channels 32 may be directly coupled to their respective antenna elements 18a and 18b for improved performance. Modular element assembly 22″ may also utilize a signal distribution circuit 34, coldplate 26, and/or support structure that is common to both antenna arrays 12a and 12b.

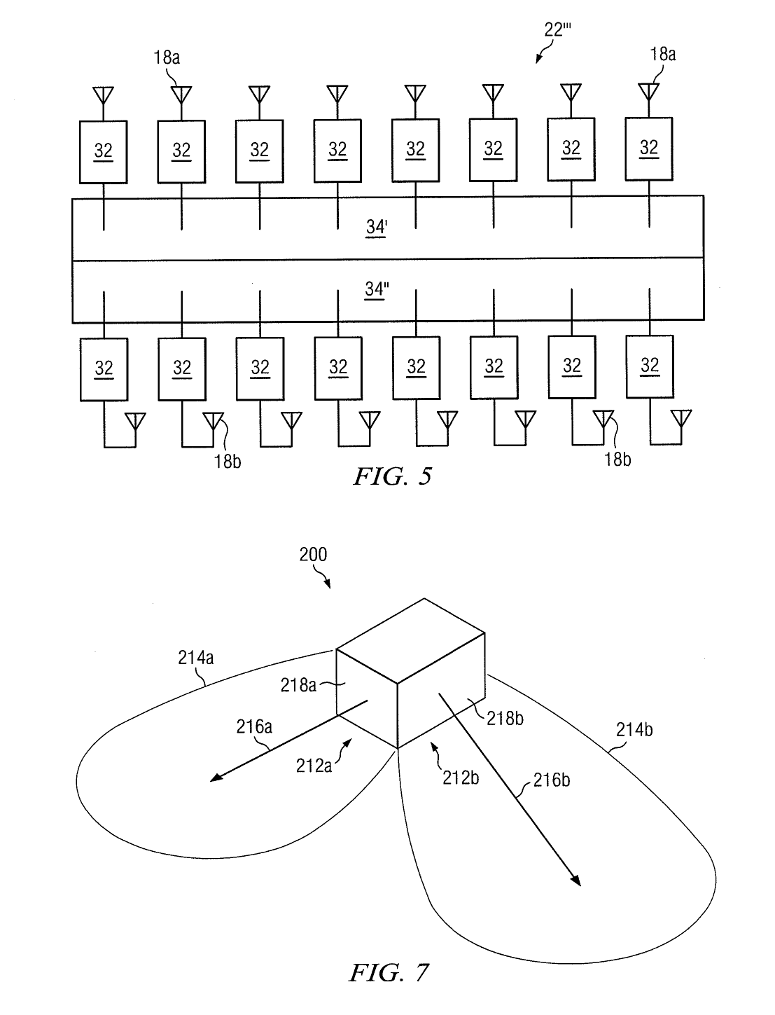

FIG. 5 is a schematic diagram showing another coupling arrangement of the various components that may be implemented on another embodiment of a modular element assembly 22″′ of FIG. 2. This particular coupling arrangement includes multiple radiating elements 18a and corresponding signal channels 32 that form first antenna array 12a, and multiple radiating elements 18b and corresponding signal channels 32 that form second antenna array 12b. The coupling arrangement also includes two signal distribution circuits 34′ and 34″, one for each antenna array 12a and 12b.

Each signal distribution circuit 34′ and 34″ functions independently of each other for unique, simultaneous control over their respective antenna elements 18a and 18b. For example, a beam generated by first antenna array 12a may be steered in one direction, while the other beam generated by second antenna array 12b is steered in another direction independently of the direction in which the beam is steered. Time or frequency modulation of the signals may be utilized to provide isolation. Modular element assembly 22″′ may provide performance advantages similar to that of modular element assembly 22″. Additionally, modular element assembly 22″′ may be implemented with a common cooling system and/or support structure in a similar manner to modular element assembly 22′ or modular element assembly 22″.

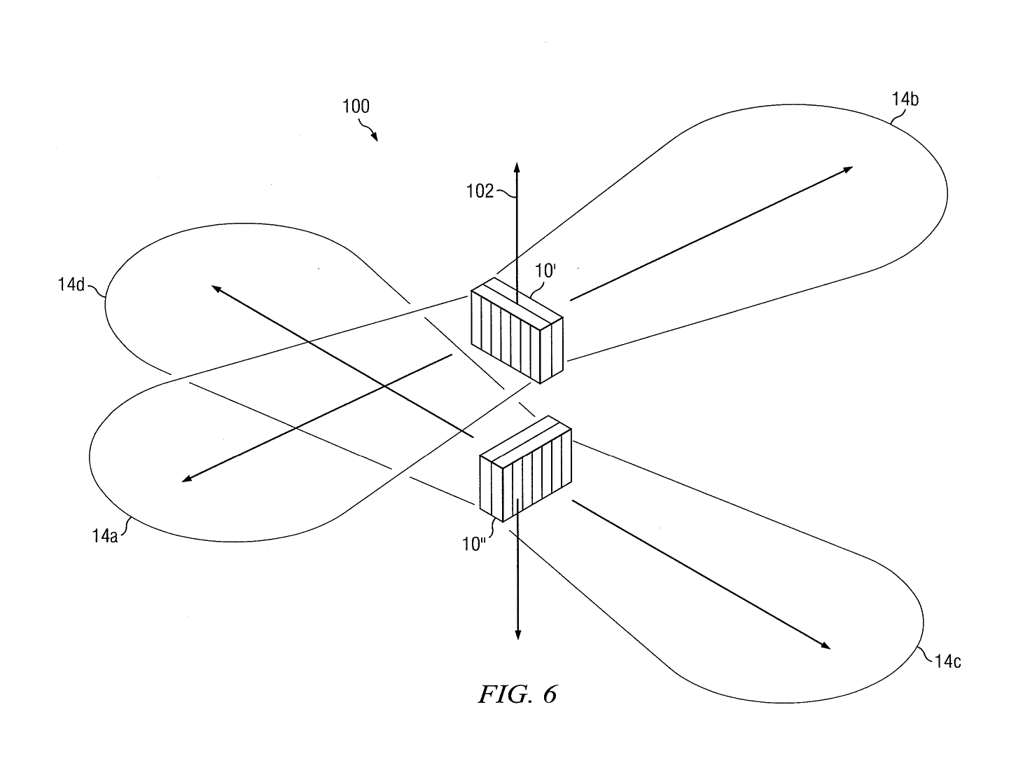

FIG. 6 is an illustration showing a perspective view of another embodiment of a combined antenna array 100 in which two multi-orientation antenna arrays 10′ and 10″ of FIG. 1 are configured in a perpendicular relationship relative to one another along a common vertical axis 102. A separation between the two antenna arrays 10′ and 10″ is provided to eliminate blockage depending upon the scan region to be implemented. Each multi-orientation antenna array 10′ and 10″ may be similar to the multi-orientation antenna array 10 of FIGS. 1 through 5. Combined antenna array 100 of FIG. 6 differs from multi-orientation antenna array 10 however in that combined antenna array 100 may have four scan volumes 14a, 14b, 14c, and 14d rather than two provided by the multi-orientation antenna array 10 of FIGS. 1 through 5.

Each multi-orientation antenna array 10 may have scan volumes 14a, 14b, 14c, and 14d that are approximately 120 degrees wide along their azimuthal extent. Antenna array 10 provides expanded azimuthal coverage relative to the azimuthal coverage provided by multi-orientation antenna array 10. As shown, combined antenna array 100 may provide azimuthal coverage that may be up to, and including a 360 degree azimuthal extent around combined antenna array 100.

FIG. 7 is an illustration showing a perspective view of another embodiment of the multi-orientation antenna array 200 according to the teachings of the present disclosure. Multi-orientation antenna array 200 has a first antenna array 212a and a second antenna array 212b that are similar in design and construction to first antenna array 12a and second antenna array 12b of the antenna array 10 of FIG. 1. First antenna array 212a includes multiple antenna elements 218a that are oriented in a plane perpendicular to direction 216a; and second antenna array 212b includes multiple antenna elements 218b that are oriented in a plane perpendicular to direction 216b. Multi-orientation antenna array 200 differs, however, in that first antenna array 212a and second antenna array 212b are arranged in their support structure such that beams may be generated in scan volume 214a and scan volume 214b having a direction 216a and direction 216b, respectively, that are oblique relative to one another.

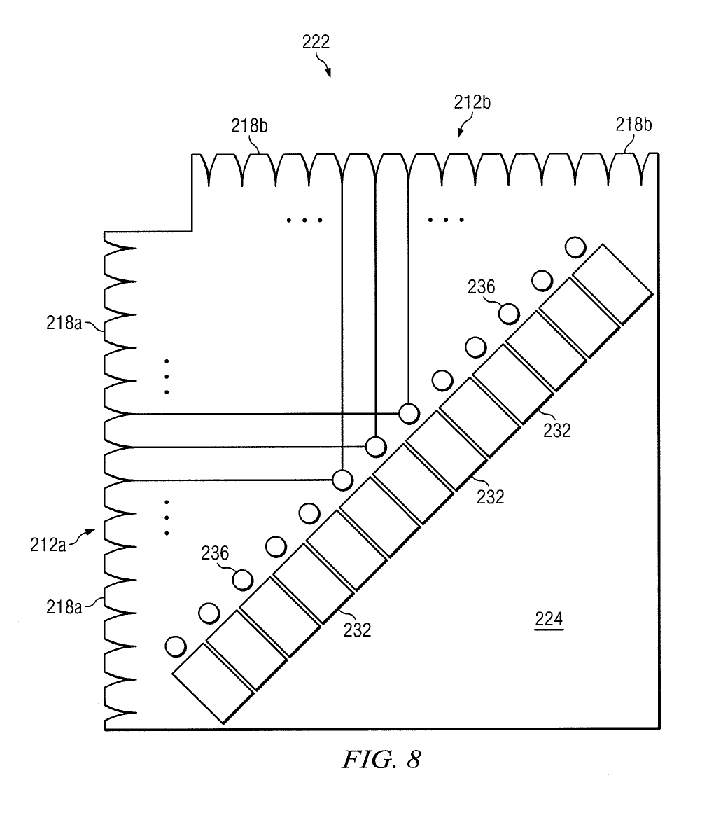

FIG. 8 illustrates a top view of one embodiment of a modular element assembly 222 that forms a portion of each antenna array 212a and 212b of FIG. 7. Modular element assembly 222 includes a circuit board 224, multiple signal channels 232, and multiple switches 236 that are coupled to multiple antenna elements 218a and 218b of each antenna array 212a and 212b, respectively. As shown, antenna elements 218a and 218b are arranged on circuit board 224 such that they form an oblique angle relative to each other, which in this particular embodiment is 90 degrees relative to each other. In other embodiments, antenna elements 218a and 218b may be arranged on circuit board 224 such that they form any desired angle relative to one another. For example, antenna elements 218a and 218b may form an angle that is less than 90 degrees or greater than 90 degrees relative to one another.

Modifications, additions, or omissions may be made to multi-orientation antenna array 10, 100, or 200 without departing from the scope of the invention. The components of multi-orientation antenna array 10, 100, or 200 may be integrated or separated. For example, circuitry comprising signal channels 32 may be provided as circuit modules separately from signal distribution circuit 34, or signal channels 32 may be integrally formed with signal distribution circuit 34. Moreover, the operations of multi-orientation antenna array 10, 100, or 200 may be performed by more, fewer, or other components. For example, each modular element assembly 22 may include other circuitry, such as power circuits or other signal conditioning circuits that conditions electrical signals received by, or transmitted to antenna elements 18a and/or 18b. Additionally, operations of signal distribution circuit 34 may be controlled by any type of controller, such as those using any suitable logic comprising software, hardware, and/or other logic. As used in this document, “each” refers to each member of a set or each member of a subset of a set.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

What is claimed is:

1. A microwave antenna apparatus comprising:
an enclosure;
a first antenna array configured in the enclosure and comprising a plurality of first antenna elements formed on a printed wiring board and oriented in a first boresight direction;
a second antenna array configured in the enclosure and comprising a plurality of second antenna elements formed on the printed wiring board and oriented in a second boresight direction that is opposite of the first boresight direction; and
a plurality of signal channels that are each coupled to each of the plurality of first antenna elements and the second antenna elements through a switch such that the plurality of signal channels are common to the plurality of first antenna elements and the plurality of second antenna elements;
a signal distribution circuit that is alternatively coupled to the plurality of first antenna elements and the plurality of second antenna elements;
wherein the first antenna array and the second antenna array share a common cooling system.

2. An antenna apparatus comprising:
a support structure;
a first antenna array configured in the support structure and comprising a plurality of first antenna elements oriented in a first boresight direction;
a second antenna array configured in the support structure and comprising a plurality of second antenna elements oriented in a second boresight direction that is different from the first boresight direction; and
a plurality of switches that alternatively couples corresponding ones of the plurality of first antenna elements or the plurality of second antenna elements to a signal distribution circuit.

3. The antenna apparatus of claim 2, wherein the second boresight direction is opposite to the first boresight direction.

4. The antenna apparatus of claim 2, wherein the second boresight direction is oriented at an oblique angle relative to the first boresight direction.

5. The antenna apparatus of claim 2, wherein the first antenna array and the second antenna array share a common cooling system.

6. The antenna apparatus of claim 2, wherein the first antenna array and the second antenna array share a common power distribution circuit.

7. The antenna apparatus of claim 2, further comprising a plurality of signal channels that are coupled between corresponding ones of the plurality of switches and the signal distribution circuit such that the plurality of signal channels are common to the plurality of first antenna elements and the plurality of second antenna elements.

8. The antenna apparatus of claim 2, further comprising a plurality of first signal channels and a plurality of second signal channels, the plurality of first signal channels being coupled between the plurality of first antenna elements and the plurality of switches, the plurality of second signal channels being coupled between the plurality of second antenna elements and the plurality of switches.

9. The antenna apparatus of claim 2, wherein the plurality of first antenna elements and the plurality of second antenna elements are formed on a common printed wiring board.

10. The antenna apparatus of claim 2, wherein the plurality of first antenna elements and the plurality of second antenna elements comprise slotline radiators.

11. A first antenna apparatus of claim 2 coupled to a second antenna apparatus of claim 2, the first and second antenna array of the first antenna apparatus oriented in a first and second boresight direction that is perpendicular to the first and second boresight direction of the first and second antenna array of the second antenna apparatus.

12. A method comprising:
generating a first beam in a first boresight direction by a first antenna array configured in a support structure, the first antenna array comprising a plurality of first antenna elements; and
generating a second beam in a second boresight direction by a second antenna array configured in the support structure, the second antenna array comprising a plurality of second antenna elements, the second boresight direction being different from the first boresight direction.
wherein the first beam and the second beam are generated using a plurality of switches that alternatively couple corresponding ones of the plurality of first antenna elements or the plurality of second antenna elements to a signal distribution circuit.

13. The method of claim 12, wherein the second boresight direction is opposite to the first boresight direction.

14. The method of claim 12, wherein the second boresight direction is oblique to the first boresight direction.

15. The method of claim 12, further comprising cooling the first antenna array and the second antenna array using a common cooling system.

16. The method of claim 12, further comprising powering the first antenna array and the second antenna array using a common power distribution circuit.

17. The method of claim 12, further comprising alternatively coupling, using a plurality of switches, a plurality of signal channels between the plurality of first antenna elements and the second antenna elements.

18. The method of claim 12, further comprising alternatively coupling, using a plurality of switches, a signal distribution circuit between a plurality of first signal channels and a plurality of second signal channels, the plurality of first antenna elements coupled to the plurality of first signal channels and the plurality of second antenna elements coupled to the plurality of second signal channels.

19. The method of claim 12, further comprising forming the plurality of first antenna elements and the plurality of second antenna elements on a common printed wiring board.

20. The method of claim 12, wherein the plurality of first antenna elements and the plurality of second antenna elements comprise slotline radiators.

21. The method of claim 12, further comprising generating a third beam in a third boresight direction by a third antenna array, and a fourth beam in a fourth boresight direction by a fourth antenna array, the third antenna array and the fourth antenna array configured in a second support structure.
